(19) United States
(12) Patent Application Publication
(10) Pub. No.: US 2005/0140133 A1
(43) Pub. Date: Jun. 30, 2005

(54) Book and method of advertising within the book

(75) Inventor: Barbara Rae Ryan, Chicago, IL (US)

Correspondence Address: MICHAEL BEST & FRIEDRICH, LLP, 100 E WISCONSIN AVENUE, MILWAUKEE, WI, 53202, US

(73) Assignee: Sears Brands LLC, Hoffman Estates, IL (US)

(21) Appl. No.: 10/746,086

(22) Filed: Dec. 26, 2003

(51) Int. Cl. B42D 5/00; B42D 1/00

(52) U.S. Cl. 281/38

(57) ABSTRACT

A picture storybook including a plurality of pages and illustrations. The illustrations include depictions of a character and/or a product available for purchase from a retail store.

### BACKGROUND OF THE INVENTION

The competition to attract consumers in the retail industry is substantial. Consumers have increasingly more choices in the variety of goods and services available, and how and where to make goods and services purchases. In addition, the proliferation of advertising materials and Internet sites have made product selection and price comparison easier for consumers.

Over the years, manufacturers and retailers have used various methods to entice consumers to shop at and return to their store to purchase products or services. Many retailers mail advertising materials such as catalogs, brochures, mailings, and newspaper inserts promoting various products to consumers.

Generally, newspapers include advertising inserts, known as free-standing-inserts or preprints. A large percentage of the adult population reads or looks at preprints, and the average preprint is retained for a short period of time. Preprints and other advertising materials are often available in racks at the entrance of retail stores. Preprints are also individually mailed to consumers' homes.

The average U.S. household receives 170 catalogs a year. The average response rate to a catalog (i.e., an order is placed) is 2.53%, therefore, most catalogs get discarded by consumers. The proliferation and similarity of catalog mailings has contributed to the low response rates and declining effectiveness as a sales medium.

Consumers generally do not review the majority of the catalogs or printed advertisements more than once before they get discarded. Marketing success for retailers sometimes depends on the number of times the consumer reviews and the length of time the consumer retains the catalog or printed advertisement. Generally, if the consumer retains the catalog or printed advertisement for a longer period of time before discarding it, the better the chances are the consumer will purchase a product from the catalog or visit an associated retail store. The ineffectiveness of catalogs and printed advertisements, which consumers feel lacks differentiation, has been linked to declining retail sales performance.

### SUMMARY OF THE INVENTION

Generally, children read the same storybook over and over again. Furthermore, parents keep children's storybooks for a long time. Studies indicate that 39% of parents regularly read to their children.

Accordingly, there is an opportunity to market products and services through stories to children and parents because storybooks are retained for a long period of time and are read more than once.

There is also an opportunity to market products and services through stories to different age groups utilizing various themes, plots, and characters.

In one embodiment, the invention provides a book comprising a plurality of pages, a story printed on the plurality of pages, and an illustration printed on each page, the illustrations including a character and a product available for purchase, the illustration depicting the character using the product.

In another embodiment, the invention provides a book comprising a plurality of pages including an image of a product available for purchase and a character, and a story printed on the plurality of pages, the story related to the product and the character, the image illustrating the character using the product.

In yet another embodiment, the invention provides a method of advertising. The method comprises creating a story having a character, printing a book including a plurality of pages and images, the book including the story printed on the plurality of pages, the images including the character, and displaying a plurality of products available for purchase in the plurality of images, the plurality of products being used by the character.

In another embodiment, the invention provides a method of advertising a product available for purchase from a retail store. The method comprises printing a book including a plurality of pages and images, the book including a story printed on the plurality of pages, the story including a character illustrated in the images, the images displaying the character using the product, and mailing the book to a plurality of consumers, the book including an invitation to the consumer to go to the retail store.

### BRIEF DESCRIPTION OF THE DRAWINGS

FIG. 1 is a perspective view of a book including the present invention.

FIG. 2 is a perspective view of a page of the book illustrated in FIG. 1.

### DETAILED DESCRIPTION

Before any embodiments of the invention are explained in detail, it is to be understood that the invention is not limited in its application to the details of construction and the arrangement of components and/or assemblies set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings.

Retail stores provide consumers with advertisements, catalogs, preprints, fliers, newspapers, and other advertising materials (collectively referred to as “advertisements”) to inform the consumers of the types of products and/or services the retail store offers. Retail stores also provide consumers with catalogs to increase sales and boost profits by getting the consumer to order products and/or services from the catalog by mail, phone, and the Internet or by entering the retail store establishment to directly purchase products and/or services. Retail stores also present marketing programs and incentives to consumers in the advertisements to get new and existing consumers to purchase products and/or services through the mail, phone, and the Internet or at the retail store.

One goal of the retail store is to develop techniques that will continually attract new and existing consumers to buy goods and services from the retailer. It is also a goal of the retail store to lure consumers away from other competitor retail stores.

There are many ways that the retail store can meet these goals. Generally, the retail store needs to communicate with the consumer through a form of media beyond providing in-store information and existing as a brick-and-mortar store and having an Internet presence. One technique is to communicate with consumers through advertisements to try to get the consumer's attention and try to get them into the retail store or on the retail store's Internet web site. Another technique is to communicate with consumers by broadcasting advertisements on radio, television, and the Internet. Another technique to communicate with consumers is through direct mail campaigns that target certain consumers based on demographics. Another technique is to formulate and generate advertisements for products and services in the form of a storybook.

The invention relates to a storybook combined with a catalog for entertainment and advertising purposes. The storybook includes a character(s) that is illustrated using or interacting with the retail store's products and/or performing or demonstrating the services provided by the retail store.

Many movies, television shows, and cartoons develop likable and well-known characters such Harry Potter and Disney characters, such as Cinderella, Jasmine, Belle, Woody, and Buzz Lightyear. The characters become popular with a specific age genre that licensing of the characters and their images has proven to be lucrative to the character's owner. The images of these characters can be found on clothing, toys, games, Halloween costumes, bedding, and other household merchandise. Children and adults are eager to have items used by these beloved characters.

Marketing to children and the young-adult population is important to retail stores because children and young-adults influence billions of dollars in purchases of goods and services each year. Because of a trend in child rearing toward a more consultative or shared-power philosophy, kids are gaining more influence on family purchase decisions. The influence kids have on family purchase decisions jumped from $5 billion in the 1960s to $188 billion in 2000, and impacts products as diverse as cereal, clothing, and family cars.

In addition, providing entertainment is a growing method of increasing sales for companies not traditionally viewed as entertainers. For example, Rain Forest Cafe provides moving and noise-making animal characters on walls and elaborate fish tanks in its restaurants. Bookstores, such as Barnes and Noble and Borders provide readings and book signings. Starbucks occasionally offers free music on weekend evenings. Shopping malls sponsor face painting, celebrity visits, and holiday pictures with Santa Claus and the Easter Bunny. For example, Mall of America, has a full amusement park with rides, skating rinks, and magic shows for entertaining the entire family. Entertaining is becoming an important way for retailers and restaurants to build loyal patronage, increase traffic, and boost sales.

Integrating a storybook with entertainment and advertising materials increases the likelihood of influencing the readers and listeners (e.g., children, young adults, parents, and adults) to make purchases of products and services at the retail store or through the mail, phone, or Internet. The storybook can be repeatedly used and is unlikely to be discarded.

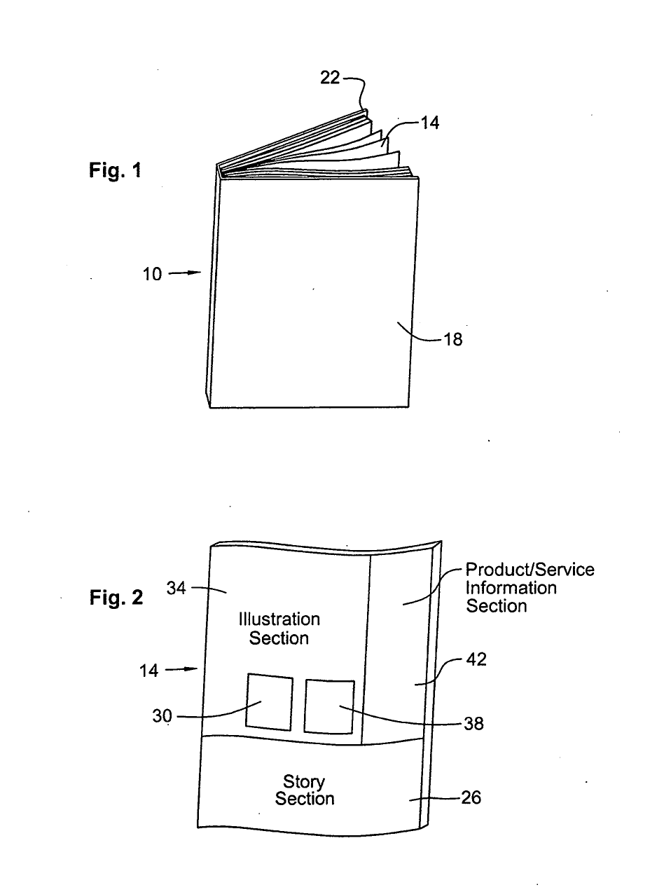

FIGS. 1-2 illustrate one embodiment of the present invention. FIG. 1 illustrates a book 10 including a plurality of pages 14. Book, as used herein can include hard or soft cover books, magazines, catalogs, pamphlets, brochures, newspapers, envelopes, preprints, and other printed materials. Generally, the book 10 includes a front cover 18 and a back cover 22 with the plurality of pages positioned between the front cover 18 and back cover 22. However, the book 10 does not require a front cover 18 and/or a back cover 22, and the book 10 can include a single sheet or piece of paper.

FIG. 2 illustrates a sample page 14 from the book 10. The sample layout of the page 14 is illustrated and discussed as only one example, and the invention is not limited to the layout shown. It is understood that many different types and kinds of layouts are possible for the page 14. In addition, each page 14 in the book 10 can have the same or a different layout. The book 10 can vary in size and each page 14 can have a different size and/or shape than shown in the figures. The page 14 includes a story section 26. The story section 26 can include a fiction or non-fiction story related to a character(s) 30, thing(s), place(s) or other person(s). The page 14 also includes an illustration section 34. The illustration section 34 includes drawings, sketches, photographs, images, and the like in color and/or black and white illustrating the character 30 and surrounding environment as it relates to the theme or plot of the story. The illustration section 34 also includes drawings, sketches, photographs, images, and the like of the retail store's products 38 and services. The products 38 can be used by the character(s) 30 and the retail store's services can be shown as being performed by the character(s) 30. The products 38 can be illustrated and do not have to be used by the character(s) 30 and the services do not have to be performed by the character(s) 30. The page 14 includes a product(s)/service(s) information section 42. Each product 38 and service shown in the illustration section 34 or described in the story section 26 is identified by a number or letter or other identification convention, such that each product 38 and service can be described in the product/service information section 42. In addition, the product(s)/services(s) information section 42 can include additional products 38 and services that are not illustrated in the illustration section 34 or mentioned in the story section 26. Generally, the information provided in the product(s)/service(s) information section 42 can include, size, color, material, and price, but any other details about the product or service can also be provided in the product/service information section 42. Any number of products and/or services can be presented on the page 14. The page 14 can include all, one, or two the sections 26, 34, 42 and the number of sections 26, 34, 42 on each page 14 of the book 10 can vary.

The book 10 can be mailed to households randomly and can be mailed to select households based on the type of story, products and services being presented and offered in the book 10. The book 10 can also be mailed to direct mail listings based on purchasing decisions and/or demographics. The book 10 can be made available at the retail store or can be mailed or provided to specific consumers based on participation in a club. For example, the story can include a character 30 or characters that appeal to children, the products illustrated can include, but are not limited to, clothing (with or without the character's image), toys (with or without the character's image), school supplies (with or without the character's image), and hygiene products (with or without the character's image), and the services illustrated and discussed can include, but are not limited to, vision screening, dental check-ups, and doctor check-ups.

As another example, the story can include a character 30 or characters that appeal to adults, the products illustrated can include, but are not limited to, clothing (with or without the character's image), recreation products (with or without the character's image), media products (with or without the character's image), tools (with or without the character's image), and home-improvement items (with or without the character's image), and the services illustrated and discussed can include, but are not limited to, vision screening, dental check-ups, doctor check-ups, spa services, club memberships, banking, and financial planning.

The book 10 can include coupons, gift certificates, gift cards, (and other money saving tools), invitations to special events, and advanced notices of sales and the arrival of new merchandise. The book 10 can be mailed and made available on a periodic basis or at any time desired by the retail store. Special issues of the book 10 can be created to accommodate specific times of the year (e.g., Christmas theme, Halloween theme, etc.) or for special occasions for the recipient (e.g., birthday, new baby, etc.).

In summary, the invention provides a marketing opportunity to present products and services available for purchase to consumers that are described and illustrated with a character within a story. The products and services illustrated provide additional props for the characters in the story and support the plot or theme of the story.

Various features and advantages of the invention are set forth in the following claims.

1. A book comprising:
a plurality of pages;
a story printed on the plurality of pages; and
an illustration printed on each page, the illustrations including a character and a product available for purchase, the illustration depicting the character using the product.

2. The book as claimed in claim 1, further comprising a coupon printed on at least one page.

3. The book as claimed in claim 1, further comprising an invitation printed on at least one page, the invitation informing the reader of the book, to visit a retail store associated with the book.

4. The book as claimed in claim 1, wherein at least one page includes an illustration section that includes the character, a product information section that includes a product description, and a story section that includes the story.

5. The book as claimed in claim 4, wherein the product information section includes one of a size, a color, a product number, a fabric content, and a manufacturer brand name.

6. The book as claimed in claim 1, wherein the product available for purchase is related to the story.

7. A book comprising:
a plurality of pages including an image of a product available for purchase and a character; and
a story printed on the plurality of pages, the story related to the product and the character, the image illustrating the character using the product.

8. The book as claimed in claim 7, further comprising a coupon printed on at least one page.

9. The book as claimed in claim 7, further comprising an invitation printed on at least one page, the invitation informing the reader of the book, to visit a retail store associated with the book.

10. The book as claimed in claim 7, wherein at least one page includes an illustration section that includes the character, a product information section that includes a product description, and a story section that includes the story.

11. The book as claimed in claim 10, wherein the product information section includes one of a size, a color, a product number, a fabric content, and a manufacturer brand name.

12. A method of advertising, the method comprising:
creating a story having a character;
printing a book including a plurality of pages and images, the book including the story printed on the plurality of pages, the images including the character; and
displaying a plurality of products available for purchase in the plurality of images, the plurality of products being used by the character.

13. The method of advertising as claimed in claim 12, wherein the book is created by a retail store, and further comprising mailing the book to a consumer.

14. The method of advertising as claimed in claim 12, further comprising a coupon printed on at least one page.

15. The method of advertising as claimed in claim 12, wherein at least one page includes an illustration section that includes the character and the product, a product information section that includes a product description, and a story section that includes the story.

16. The method of advertising as claimed in claim 15, wherein the product information section includes one of a size, a color, a product number, a fabric content, and a manufacturer brand name.

17. A method of advertising a product available for purchase from a retail store, the method comprising:
printing a book including a plurality of pages and images, the book including a story printed on the plurality of pages, the story including a character illustrated in the images, the images displaying the character using the product; and
mailing the book to a plurality of consumers, the book including an invitation to the consumer to go to the retail store.

18. The method of advertising as claimed in claim 17, wherein the book includes a coupon printed on at least one page.

19. The method of advertising as claimed in claim 17, wherein the coupon can be used in a retail store different than the retail store that mailed the book.
